(19) United States
(12) Patent Application Publication
(10) Pub. No.: US 2009/0029248 A1
(43) Pub. Date: Jan. 29, 2009

(54) Nonaqueous electrolyte and secondary battery containing same

(76) Inventors: Masaki Deguchi, Osaka (JP); Tooru Matsui, Osaka (JP); Hiroshi Yoshizawa, Osaka (JP)

Correspondence Address: MCDERMOTT WILL & EMERY LLP, 600 13TH STREET, NW, WASHINGTON, DC, 20005-3096, US

(21) Appl. No.: 11/665,076

(22) PCT Filed: Jan. 17, 2006
(86) PCT No.: PCT/JP06/00487

§ 371 Date: Apr. 11, 2007

(30) Foreign Application Priority Data
Jan. 26, 2005 (JP) 2005-018067

(51) Int. Cl. H01M 10/02

(52) U.S. Cl. 429/188

(57) ABSTRACT

Provided is a non-aqueous electrolyte for a secondary battery including a non-aqueous solvent, a solute dissolved in the non-aqueous solvent, and an additive, in which the additive includes an unsaturated chain hydrocarbon compound having two or more carbon-carbon unsaturated bonds and including a main chain having five or more carbon atoms. The unsaturated chain hydrocarbon compound preferable as the additive is 1,3-hexadiene or 2,4-hexadiene. The amount of the unsaturated chain hydrocarbon compound is preferably 0.1 to 10 parts by weight per 100 parts by weight of the non-aqueous solvent.

### TECHNICAL FIELD

The present invention relates to non-aqueous electrolyte secondary batteries, and in particular relates to improvement of non-aqueous electrolytes.

### BACKGROUND ART

At present, in the field of non-aqueous electrolyte secondary batteries, studies on lithium ion secondary batteries with high voltage and high energy density are being actively carried out. The non-aqueous electrolyte secondary batteries comprise a positive electrode capable of absorbing and desorbing lithium, a negative electrode capable of absorbing and desorbing lithium, a separator interposed between the positive electrode and the negative electrode, and a non-aqueous electrolyte.

The positive electrode comprises an active material composed of, for example, a lithium-containing transition metal oxide such as LiCoO₂. The negative electrode comprises an active material composed of, for example, a carbonaceous material. The non-aqueous electrolyte comprises a non-aqueous solvent and a solute dissolved in the non-aqueous solvent. The non-aqueous solvent includes cyclic carbonic acid ester, chain carbonic acid ester, cyclic carboxylic acid ester and the like. The solute includes lithium hexafluorophosphate (LiPF₆), lithium tetrafluoroborate (LiBF₄) and the like.

For the purpose of improving battery performances, there has been proposed to include an additive in the non-aqueous electrolyte. For example, one proposal is that vinylene carbonate (VC) or vinyl ethylene carbonate (VEC) be added to the non-aqueous electrolyte. The purpose of this proposal is to improve the charge/discharge characteristics of batteries. The VC or VEC is decomposed on the negative electrode to form a protective coating. It is considered that this suppresses a side reaction of the non-aqueous electrolyte and the negative electrode active material (Refer to Patent Documents 1 and 2).

Another proposal is that an unsaturated cyclic hydrocarbon compound such as 1,5-cyclooctadiene be added to the non-aqueous electrolyte. The purpose of this proposal is to improve the cycle reliability and the storage stability of batteries. The 1,5-cyclooctadiene or the like is intercalated between the layers of carbon serving as a negative electrode active material, while being in a solvated state with lithium ions. It is considered that this makes it possible to obtain a stable charged state (Refer to Patent Document 3).

Yet another proposal is that 2,3-dimethyl-1,3-butadiene or the like be added to the non-aqueous electrolyte. The purpose of this proposal is to improve the safety of batteries during overcharging. The 2,3-dimethyl-1,3-butadiene or the like is oxidized and polymerized on the positive electrode during overcharging of batteries. It is considered that this prevents the reduction in thermal stability of the positive electrode active material (Refer to Patent Document 4).

Patent Document 1: Japanese Laid-Open Patent Publication No. 2003-151621

Patent Document 2: Japanese Laid-Open Patent Publication No. 2003-31259

Patent Document 3: Japanese Laid-Open Patent Publication No. Hei 9-35746

Patent Document 4: Japanese Laid-Open Patent Publication No. 2001-15158

### DISCLOSURE OF THE INVENTION

### Problem to be Solved by the Invention

When VC or VEC is added to the nonaqueous electrolyte according to the conventional proposal, the protective coating formed on the negative electrode is peeled off in a high temperature, and thus the side reaction of the non-aqueous electrolyte and the negative electrode active material becomes active. Moreover, the side reaction of the non-aqueous electrolyte and the positive electrode active material cannot be suppressed even with addition of VC or VEC, and therefore the reduction in cycle characteristics cannot be sufficiently prevented.

Similarly, when the unsaturated cyclic hydrocarbon compound such as 1,5-cyclooctadiene is added to the non-aqueous electrolyte, the side reaction of the non-aqueous electrolyte and the negative electrode active material or the positive electrode active material cannot be suppressed in a high temperature. Hence, the reduction in cycle characteristics cannot be sufficiently prevented.

Further, when 2,3-dimethyl-1,3-butadiene or the like is added to the non-aqueous electrolyte, insertion to the active material and release from the active material of lithium ions are inhibited. Hence, the charge/discharge efficiency is decreased and the cycle characteristics are degraded.

### Means for Solving the Problem

The present invention has been achieved in view of the above and intends to provide a non-aqueous electrolyte exhibiting favorable charge/discharge cycle characteristics even in a high temperature environment and a secondary battery (non-aqueous electrolyte secondary battery) containing the same.

Specifically, the present invention relates to a non-aqueous electrolyte for a secondary battery comprising a non-aqueous solvent, a solute dissolved in the non-aqueous solvent, and an additive, in which the additive comprises an unsaturated chain hydrocarbon compound having two or more carbon-carbon unsaturated bonds and including a main chain having five or more carbon atoms (hereinafter referred to as a C5 or more unsaturated chain hydrocarbon).

The C5 or more unsaturated chain hydrocarbon is represented by, for example, the general formula (1):

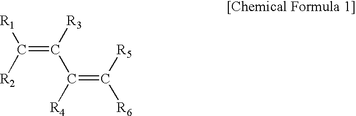

wherein each of R₁, R₂, R₃, R₄, R₅ and R₆ independently represents a hydrogen atom or an alkyl group having one to five carbon atoms, and at least one of R₁ to R₆ is an alkyl group whose main chain has five or more carbon atoms.

It is preferable that the C5 or more unsaturated chain hydrocarbon is 1,3-hexadiene or 2,4-hexadiene.

It is preferable that an amount of the C5 or more unsaturated chain hydrocarbon is 0.1 to 10 parts by weight per parts by weight of the non-aqueous solvent.

It is preferable that the additive further comprises at least one selected from the group consisting of vinylene carbonate and vinyl ethylene carbonate.

It is preferable that the solute comprises lithium tetrafluoroborate (LiBF₄).

The present invention further relates to a non-aqueous electrolyte secondary battery comprising a positive electrode capable of absorbing and desorbing lithium, a negative electrode capable of absorbing and desorbing lithium, a separator interposed between the positive electrode and the negative electrode, and the non-aqueous electrolyte as described above.

### EFFECT OF THE INVENTION

By adding the C5 or more unsaturated chain hydrocarbon to the non-aqueous electrolyte, in a high temperature environment, the side reaction of the non-aqueous electrolyte and the negative electrode active material or the positive electrode active material can be suppressed, and the degradation in cycle characteristics can be inhibited. As a result, a non-aqueous electrolyte secondary battery having favorable charge/discharge characteristics regardless of environment temperature can be obtained.

### BRIEF DESCRIPTION OF THE DRAWINGS

FIG. 1 A schematic vertical sectional view of a cylindrical non-aqueous electrolyte secondary battery of the present invention.

### BEST MODE FOR CARRYING OUT THE INVENTION

A non-aqueous electrolyte of the present invention comprises a non-aqueous solvent, a solute dissolved in the non-aqueous solvent, and an additive. The additive comprises an unsaturated chain hydrocarbon compound having two or more carbon-carbon unsaturated bonds and includes a main chain having five or more carbon atoms (a C5 or more unsaturated chain hydrocarbon).

The C5 or more unsaturated chain hydrocarbon forms an extremely strong protective coating on both the negative electrode and the positive electrode. The strong protective coating is not easily peeled off from the surface of the negative electrode and the surface of the positive electrode even in a high temperature environment. Therefore, by adding the C5 or more unsaturated chain hydrocarbon to the non-aqueous electrolyte, the side reaction of the non-aqueous electrolyte and the negative electrode active material or the positive electrode active material can be suppressed even in a high temperature environment. The reason for this is presumably as follows.

The C5 or more unsaturated chain hydrocarbon is reduced on the negative electrode and is oxidized on the positive electrode, and thus is polymerized on each electrode to form a protective coating composed of polymers. In the C5 or more unsaturated chain hydrocarbon, there exist two or more reaction sites per one molecule that undergo reduction or oxidation. Therefore, in the C5 or more unsaturated chain hydrocarbon, polymerization reaction is initiated from two or more reaction sites. As a result, the degree of polymerization of polymers produced as a protective coating is high and the polymers produced have a large molecular weight. In other words, a closely-packed and strong protective coating is formed on the surface of the negative electrode and the surface of the positive electrode. It is considered that the side reaction of the non-aqueous electrolyte and the negative electrode active material or the positive electrode active material can be suppressed even in a high temperature environment because of the presence of this strong coating.

It should be noted that the unsaturated cyclic hydrocarbon compound such as 1,5-cyclooctadiene (refer to Patent Document 3) is structurally different from the C5 or more unsaturated chain hydrocarbon in that the molecule of the unsaturated cyclic hydrocarbon compound has a cyclic structure. Since the unsaturated cyclic hydrocarbon compound such as 1,5-cyclooctadiene has a cyclic structure, it has a large steric hindrance. Accordingly, the attack on monomer by a carbanion or a carbocation present at the end of a growing chain is easily inhibited. Consequently, the degree of polymerization of the obtained polymers becomes low. A coating composed of such polymers is easily peeled off from the surface of the negative electrode and the surface of the positive electrode in a high temperature environment.

Furthermore, the 2,3-dimethyl-1,3-butadiene (refer to Patent Document 4) is structurally different from the C5 or more unsaturated chain hydrocarbon in that the main chain of 2,3-dimethyl-1,3-butadiene has four carbon atoms. Since an unsaturated chain hydrocarbon compound including a main chain having four carbon atoms (a butadiene derivative) has an extremely small molecular size, it scarcely has a steric hindrance and the polymerization proceeds abruptly. Consequently, the degree of polymerization of the obtained polymers becomes extremely high. This inhibits the insertion to the active material and the release from the active material of lithium ions, resulting in reduction in the charge/discharge efficiency.

In contrast, since the C5 or more unsaturated chain hydrocarbon has a chain-like molecular structure, it has a relatively small steric hindrance and the attack on monomer by a carbanion or a carbocation present at the end of a growing chain occurs smoothly. In other words, the polymerization reactions on the negative electrode and the positive electrode proceed smoothly and an extremely strong protective coating is formed on each electrode. As a result, the side reaction of the non-aqueous electrolyte and the negative electrode active material or the positive electrode active material is sufficiently suppressed.

Moreover, since the main chain of the C5 or more unsaturated chain hydrocarbon has five or more carbon atoms, there is obtained a moderate effect of steric hindrance. Consequently, the abrupt proceeding of polymerization of the C5 or more unsaturated chain hydrocarbon can be avoided and the insertion to the active material and the release from the active material of lithium ions are not significantly inhibited.

As described above, the effect obtained with the C5 or more unsaturated chain hydrocarbon is higher than that obtained with the conventionally proposed additives in terms of improvement of the charge/discharge cycle characteristics.

Usable as the non-aqueous solvent are, for example, cyclic carbonic acid ester, chain carbonic acid ester, cyclic carboxylic acid ester. The cyclic carbonic acid ester is exemplified by propylene carbonate (PC), ethylene carbonate (EC) and the like. The chain carbonic acid ester is exemplified by diethyl carbonate (DEC), ethyl methyl carbonate (EMC), dimethyl carbonate (DMC) and the like. The cyclic carboxylic acid ester is exemplified by γ-butyrolactone (GBL), γ-valerolactone (GVL) and the like. Although these may be used singly as the non-aqueous solvent, it is preferable to use them in combination of two or more.

As the solute, a lithium salt is preferably used. The lithium salt is exemplified by LiClO₄, LiBF₄, LiPF₆, LiAlCl₄, LiSbF₆, LiSCN, LiCF₃SO₃, LiCF₃CO₂, Li(CF₃SO₂)₂, LiAsF₆, LiB₁₀Cl₁₀, lower aliphatic lithium carboxylic acid ester, LiCl, LiBr, LiI, LiBCl₄, borates such as lithium bis(1,2 benzenedioleate(2-)-O,O′) borate, lithium bis(2,3-naphthalenedioleate(2-)-O,O′) borate, lithium bis(2,2′-biphenyldioleate(2-)-O,O′) borate and lithium bis(5-fluoro-2-oleate-1-benzenesulfonate-O,O′) borate, and imides such as lithium bistrifluoromethanesulfonimide ((CF₃SO₂)₂NLi), lithium trifluoromethanesulfonic acid nonafluorobutanesulfonimide (LiN(CF₃SO₂)(C₄F₉SO₂)), and lithium bispentafluoroethanesulfonimide ((C₂F₅SO₂)₂NLi) and the like. Among these, LiBF₄ and LiPF₆ are particularly preferable. These may be used singly or may be used in combination of two or more.

The non-aqueous electrolyte preferably contains at least LiBF₄ as a lithium salt. The LiBF₄ is decomposed on the negative electrode and the positive electrode to generate lithium fluoride (LiF). The lithium fluoride is trapped in the interior of a polymer coating produced by polymerization of C5 or more unsaturated chain hydrocarbon. As a result, an inorganic-organic hybrid polymer coating including lithium ions is formed. Because of an excellent lithium ion conductivity of such a hybrid polymer coating, the insertion into the active material and the release from the active material of lithium ions are carried out smoothly. Hence, further improvement in cycle characteristics can be expected.

In the case where LiBF₄ and LiPF₆ are used together as a lithium salt, in view of keeping a balance between cycle characteristics and safety, the molar ratio between LiBF₄ and LiPF₆, LiBF₄:LiPF₆, is preferably 2:8 to 8:2.

The concentration of the solute in the non-aqueous solvent is preferably, for example, 0.8 to 2 mol/L, and more preferably 0.8 to 1.6 mol/L.

Usable as the C5 or more unsaturated chain hydrocarbon is, for example, a compound represented by the general formula (1):

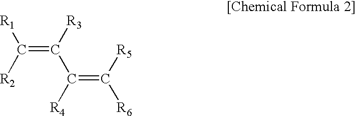

wherein each of R₁, R₂, R₃, R₄, R₅ and R₆ independently represents a hydrogen atom or an alkyl group having one to five carbon atoms, and at least one of R₁ to R₆ is an alkyl group whose main chain has five or more carbon atoms.

In the C5 or more unsaturated chain hydrocarbon represented by the general formula (1), carbon-carbon double bonds are conjugated, and π electrons are delocalized. Therefore, the reductive polymerizability or the oxidative polymerizability thereof is high, and polymerization reaction easily proceeds. For this reason, the compound represented by the general formula (1) is ideal for forming a protective coating with a high degree of polymerization.

Among the C5 or more unsaturated chain hydrocarbons represented by the general formula (1), diene, triene and tetraene including a main chain having five to eight carbon atoms are preferable, and 2,4-hexadiene and 1,3-hexadiene are particularly preferable. Since the steric hindrance of 1,3-hexadiene and 2,4-hexadiene during polymerization is appropriately small, and the polymerization reaction thereof particularly easily proceeds, a protective coating with a higher degree of polymerization is readily formed. In addition, a protective coating derived from 1,3-hexadiene or 2,4-hexadiene hardly inhibits the insertion to the active material and the release from the active material of lithium ions.

The amount of C5 or more unsaturated chain hydrocarbon included in the non-aqueous electrolyte is preferably 0.1 to 10 parts by weight per 100 parts by weight of non-aqueous solvent, and more preferably 1 to 5 parts by weight. And when expressed in terms of a proportion to the whole non-aqueous electrolyte, the amount is preferably 0.8 to 4.5% by weight. When the amount of the C5 or more unsaturated chain hydrocarbon is less than 0.1 part by weight, the effect obtained by addition thereof may become too small. The amount of the C5 or more unsaturated chain hydrocarbon is more than 10 parts by weight, coatings to be formed on the surface of the negative electrode and the surface of the positive electrode may become too thick, and the resistance may be increased. When this occurred, the insertion to the active material and the release from the active material of lithium ions may be inhibited, the charge/discharge efficiently may be reduced and the cycle characteristics may be degraded.

The additive to be contained in the non-aqueous electrolyte preferably further includes at least one selected from the group consisting of vinylene carbonate (VC) and vinyl ethylene carbonate (VEC) (hereinafter referred to as an unsaturated cyclic carbonic acid ester). The unsaturated cyclic carbonic acid ester is known to be decomposed on the negative electrode to form a coating. It is considered that the unsaturated cyclic carbonic acid ester forms a thin coating also on the positive electrode. A composite coating (copolymer) formed of the C5 or more unsaturated chain hydrocarbon and the unsaturated cyclic carbonic acid ester has a function of significantly enhancing the adhesiveness between the positive/negative electrode and the separator interposed between the positive electrode and the negative electrode. The amount of the unsaturated cyclic carbonic acid ester is preferably 0.1 to 10 parts by weight per 100 parts by weight of non-aqueous solvent, and particularly preferably 1 to 5 parts by weight. And when expressed in terms of a proportion to the whole non-aqueous electrolyte, the amount is preferably 0.8 to 4.5% by weight.

Since the polymerization reaction of the C5 or more unsaturated chain hydrocarbon can be proceeded at two or more reaction sites, a crosslinking reaction occurs. As a result, a polymer having a three dimensional network structure is readily formed. The polymer having a three dimensional network structure is strong and rigid, and thus is hard to be peeled off from the surface of the negative electrode and the surface of the positive electrode. It should be noted, however, that the polymer having a three-dimensional network structure is poor in flexibility, and the adhesiveness with the separator becomes poor.

In the case where the additive contains the unsaturated cyclic carbonic acid ester, the crosslinking reaction of the C5 or more unsaturated chain hydrocarbon is mitigated. Therefore, a glass transition temperature of the copolymer produced is low, and an elastic modulus of the composite coating in a low temperature zone to a high temperature zone is low. Because of this, the composite coating develops flexibility such that the coating can be closely adhered to the separator. Because of the enhanced adhesiveness between the coating on the surface of the electrode and the separator, even when the separator is shut down, the shrinkage of the separator is suppressed and the contact (internal short-circuit) between the positive electrode and the negative electrode is suppressed. This consequently improves the safety of a battery when the battery is subjected to an abnormal mode (for example, overcharged or heated at high temperatures). The shut down refers to a kind of safe mechanism, that is, a phenomenon in which the micropores of the separator are clogged to suppress the migration of ions between the positive electrode and the negative electrode.

The additive to be contained in the non-aqueous electrolyte may further include a benzene derivative that is decomposed during overcharge and forms a coating on the electrode to inactivate the battery. Such a benzene derivative preferably comprises a phenyl group and a cyclic group adjacent thereto. Preferable as the cyclic group are a phenyl group, a cyclic ether group, a cyclic ester group, a cycloalkyl group, a phenoxy group are the like. An example of the benzene derivative includes cyclohexylbenzene, biphenyl, diphenyl ether and the like. These may be used singly or in combination of two or more. The amount of the benzene derivative is preferably 10 parts by volume or less per 100 parts by volume of non-aqueous solvent.

Next, description will be made about the non-aqueous electrolyte secondary battery.

The non-aqueous electrolyte secondary battery comprises a positive electrode capable of absorbing and desorbing lithium, a negative electrode capable of absorbing and desorbing lithium, a separator interposed between the positive electrode and the negative electrode, and the non-aqueous electrolyte as described above.

The positive electrode comprises, for example, a positive electrode material mixture and a belt-shaped current collector carrying the positive electrode material mixture. The positive electrode material mixture contains a positive electrode active material as an essential component, and may contain optional components such as a binder and a conductive material.

For the positive electrode active material, for example, LiₓCoO₂, LiₓNiO₂, LiₓMnO₂, LiₓNi_{1-y}O₂, LiₓCo_{y}M_{1-y}O_{z}, LiₓNi_{1-y}M_{y}O_{z}, LiₓMn₂O₄, LiₓMn_{2-y}M_{y}O₄ (wherein M=at least one selected from the group consisting of Na, Mg, Sc, Y, Mn, Fe, Co, Ni, Cu, Zn, Al, Cr, Pb, Sb and B, x=0 to 1.2, y=0 to 0.9, and z=2.0 to 2.3), and the like are used. These may be used singly or in combination of two or more. The above-described value x is a value before the start of a charge/discharge operation, and increases or decreases according to the charge/discharge operation.

The negative electrode comprises, for example, a negative electrode material mixture and a belt-shaped current collector carrying the negative electrode material mixture. The negative electrode material mixture contains a negative electrode active material as an essential component, and may contain optional components such as a binder and a conductive material.

For the negative electrode active material, for example, graphites such as natural graphite (flake graphite, etc) and artificial graphite, carbon blacks such as acetylene black, Ketjen Black, channel black, furnace black, lampblack and thermal black, carbon fibers, metal fibers, an alloy, a lithium metal, a tin compound, a silicon compound, a nitride, and the like are used. These may be used singly or in combination of two or more.

For the binder to be contained in the positive electrode material mixture or the negative electrode material mixture, for example, polyethylene, polypropylene, polytetrafluoroethylene (PTFE), polyvinylidene fluoride (PVDF), tetrafluoroethylene-hexafluoropropylene copolymer (FEP), vinylidene fluoride-hexafluoropropylene copolymer, and the like are used. These may be used singly or in combination of two or more.

For the conductive material to be contained in the positive electrode material mixture or the negative electrode material mixture, for example, graphites, carbon blacks such as acetylene black, Ketjen Black, channel black, furnace black, lampblack and thermal black, carbon fibers, metal fibers, and like are used. These may be used singly or in combination of two or more.

For the current collector of the positive electrode, for example, a sheet or foil formed of stainless steel, aluminum, titanium or the like is used. As the current collector of the negative electrode, for example, a sheet or foil formed of stainless steel, nickel, cupper or the like is used. Although not necessarily limited, the thickness of the current collector is 1 to 500 μm, for example.

For the separator, a microporous thin film that is high in ion permeability and has a predetermined mechanical strength and insulating property is used. For the microporous thin film, for example, a sheet, a nonwoven fabric or a woven fabric formed of an olefin-based polymer such as polypropylene and polyethylene, glass fibers, or the like is used. The thickness of the separator is typically 10 to 300 μm.

Next, the present invention will be specifically described with reference to Examples. It is to be understood, however, the present invention is not limited to the below-described Examples.

### EXAMPLE 1

### (1) Preparation of a Non-Aqueous Electrolyte

In a nonaqueous solvent composed of a mixture of ethylene carbonate (EC) and ethyl methyl carbonate (EMC) (volume ratio, EC:EMC=1:4), LiPF₆ was dissolved at a concentration of 1.0 mol/L. To the solution thus obtained, the predetermined C5 or more unsaturated chain hydrocarbon as shown in Table 1 was added as an additive at an amount of 2 parts by weight per 100 parts by weight of non-aqueous solvent to give a non-aqueous electrolyte.

### (2) Fabrication of a Positive Electrode

85 parts by weight of lithium cobalt oxide powder as a positive electrode active material, 10 parts by weight of acetylene black as a conductive material, 5 parts by weight of polyvinylidene fluoride resin as a binder and dehydrated N-methyl-2-pyrrolidone (NMP) were mixed, whereby a positive electrode material mixture slurry was prepared. This slurry was applied on both sides of a positive electrode current collector formed of an aluminum foil and then dried and rolled to give a positive electrode.

### (3) Fabrication of a Negative Electrode

75 parts by weight of artificial graphite powder as a negative electrode active material, 20 parts by weight of acetylene black as a conductive material, 5 parts by weight of polyvinylidene fluoride resin as a binder and dehydrated NMP were mixed, whereby a negative electrode material mixture slurry was prepared. This slurry was applied on both sides of a negative electrode current collector formed of a cupper foil and then dried and rolled to give a negative electrode.

### (4) Fabrication of a Cylindrical Battery

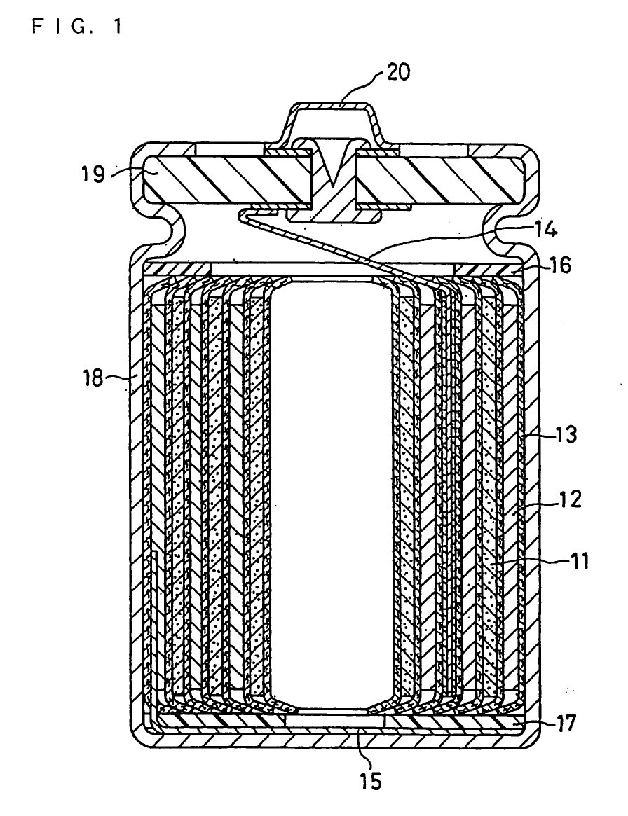

A cylindrical battery as illustrated in FIG. 1 was fabricated in the following manner.

A positive electrode 11 and a negative electrode 12 are wound spirally with a separator 13 interposed therebetween to form an electrode assembly. The electrode assembly was housed in a battery case 18 made of nickel-plated iron. To the positive electrode 11, one end of a positive electrode lead 14 made of aluminum was connected, and then the positive electrode lead was connected to the back side of a sealing plate 19 electrically connected with a positive electrode terminal 20. Moreover, to the negative electrode 12, one end of a negative electrode lead 15 made of nickel was connected, and then the negative electrode lead was connected to the bottom of the battery case 18. An insulating plate 16 and an insulating plate 17 were provided on the top of the electrode assembly and on the bottom of the electrode assembly, respectively. Thereafter, a predetermined non-aqueous electrolyte was injected into the battery case 18 and then the opening of the battery case 18 was sealed with the sealing plate 19.

### (5) Evaluation of the Battery

With respect to the battery fabricated in the above-described manner, a charge/discharge cycle of battery was repeated at 45° C. under the conditions below.

Charge: Constant current and constant voltage charge for 2.5 hours (maximum current 1050 mA, upper limit voltage 4.2 V)

Discharge: Constant current discharge (discharge current 1500 mA, discharge end voltage 3.0 V)

The discharge capacity of the battery at the 500th cycle was measured. Assuming that the discharge capacity at the 3rd cycle is 100%, a capacity retention rate of the battery at the 500th cycle was calculated. The results are shown in Table 1.

### COMPARATIVE EXAMPLE 1

A battery similar to that of Example 1 was fabricated, except that the C5 or more unsaturated chain hydrocarbon was not contained in the non-aqueous electrolyte, and then evaluated in the same manner as in Example 1. The result is shown in Table 1.

### COMPARATIVE EXAMPLE 2

A battery similar to that of Example 1 was fabricated, except that 1,5-cyclo octadiene or 2,3-dimethyl-1,3-butadiene was contained in the non-aqueous electrolyte in place of the C5 or more unsaturated chain hydrocarbon, and then evaluated in the same manner as in Example 1. The results are shown in Table 1.

TABLE 1

| | | Capacity |
|---|---|---|
| | | retention rate |
| | Type of additive | (%) |
| Ex. 1 | Piperylene | 84.0 |
| | 2,4-dimethyl-1,3-pentadiene | 84.9 |
| | 1,3-hexadiene | 86.5 |
| | 2,4-hexadiene | 86.8 |
| | 2,5-dimethyl-2,4-hexadiene | 85.1 |
| | 1,3,5-hexatriene | 82.2 |
| | 1,3,5,7-octatetraene | 81.7 |
| | 1,4-hexadiene | 82.4 |
| | 1,5-hexadiene | 83.2 |
| | 2,5-dimethyl-1,5-hexadiene | 82.5 |
| | 1,6-heptadiene | 81.0 |
| | 1,7-octadiene | 80.5 |
| Com. Ex. 1 | Nil | 40.5 |
| Com. Ex. 2 | 1,5-cyclooctadiene | 41.4 |
| | 2,3-dimethyl-1,3-butadiene | 63.3 |

As is evident from Table 1, by allowing the non-aqueous electrolyte to contain the C5 or more unsaturated chain hydrocarbon, a battery excellent in cycle characteristics at high temperatures can be obtained. This is because that the C5 or more unsaturated chain hydrocarbon formed an extremely strong protective coating on both the positive electrode and the negative electrode. Since the strong coating is hard to be peeled off from the surface of the negative electrode and the surface of the positive electrode even in a high temperature, the side reaction between the non-aqueous electrolyte and the active material was presumably suppressed even when the charge/discharge cycle was repeated at high temperatures.

It should be noted that among the C5 or more unsaturated chain hydrocarbon as shown in Table 1, the compound represented by the general formula (1), specifically, piperylene, 2,4-dimethyl-1,3-pentadiene, 1,3-hexadiene, 2,4-hexadiene and 2,5-dimethyl-2,4-hexadiene were excellent in an effect of improving the cycle characteristics at high temperatures. Since carbon-carbon double bonds are conjugated, and π electrons are delocalized in the compound represented by the general formula (1), the reductive polymerizability or the oxidative polymerizability thereof is high. Accordingly the polymerization reaction of the compound represented by the general formula (1) easily proceeds, and this presumably results in formation of a protective coating with a high degree of polymerization.

In addition, among the compounds represented by the general formula (1), 1,3-hexadiene or 2,4-hexadiene was particularly excellent in the effect of improving the cycle characteristics. This is related to that the steric hindrance of 1,3-hexadiene or 2,4-hexadiene during polymerization is appropriately small, and in particular, the polymerization reaction easily proceeds, resulting in formation of a protective coating with a higher degree of polymerization. Moreover, it is found that the protective coating derived from 1,3-hexadiene or 2,4-hexadiene hardly inhibits the insertion to the active material and the releases from the active material of lithium ions.

### EXAMPLE 2

To 100 parts by weight of a non-aqueous solvent composed of a mixture of ethylene carbonate (EC) and ethyl methyl carbonate (EMC) (volume ratio, EC:EMC=1:4), a predetermined amount of 2,4-hexadiene as shown in Table 2 was added as the C5 or more unsaturated chain hydrocarbon. In the resultant mixed solution, LiPF₆ was dissolved at a concentration of 1.0 mol/L to give a non-aqueous electrolyte. A battery similar to that of Example 1 was fabricated, except that the non-aqueous electrolyte thus obtained was used, and then evaluated in the same manner as in Example 1. The results are shown in Table 2.

TABLE 2

| | 2,4-hexadiene | Capacity retention |
|---|---|---|
| | (part by weight) | rate (%) |
| Ex. 2 | 0.05 | 70.4 |
| | 0.1 | 81.2 |
| | 0.5 | 83.5 |
| | 1 | 85.9 |
| | 2 | 86.8 |
| | 3 | 87.4 |
| | 5 | 87.6 |
| | 10 | 82.1 |
| | 20 | 74.0 |

As is evident from Table 2, when the amount of 2,4-hexadiene was less than 0.1 part by weight, the effect obtained by the C5 or more unsaturated chain hydrocarbon was small. The amount of 2,4-hexadiene was more than 10 parts by weight, the cycle characteristics at high temperatures were slightly degraded. It is conceivable that the coatings became too thick and the resistance was increased, whereby the insertion to the active material and the release from the active material of lithium ions was inhibited. From the results above, it is found that the preferred amount of 2,4-hexadiene was 0.1 to 10 parts by weight per 100 parts by weight of non-aqueous solvent.

### EXAMPLE 3

To 100 parts by weight of a non-aqueous solvent composed of a mixture of ethylene carbonate (EC), ethyl methyl carbonate (EMC) and dimethyl carbonate (DMC) (volume ratio, EC:EMC:DMC=1:1:3), a predetermined amount of vinylene carbonate (VC) and/or vinyl ethylene carbonate (VEC) as shown in Table 3 was added, and further 2 parts by weight of the C5 or more unsaturated chain hydrocarbon as shown in Table 3 was added. In the resultant mixed solution, LiPF₆ was dissolved at a concentration of 1.0 mol/L to give a non-aqueous electrolyte. A battery similar to that of Example 1 was fabricated, except that the non-aqueous electrolyte thus obtained was used, and then evaluated in the same manner as in Example 1. The results are shown in Table 3.

The batteries of Example 3 were subjected to a heat resistance test at 150° C. in a manner as described below to measure a separator shrinkage time.

### [Heat Resistance Test]

The battery was first subjected to a constant current and constant voltage charge at a maximum current of mA and an upper voltage of 4.2 V for a duration of 2.5 hours. Subsequently, the temperature of the battery was raised from 20° C. to 150° C. at a constant rate of 5° C./min. After the temperature of the battery reached 150° C., the temperature was kept at 150° C. for three hours.

When the high temperature heating causes shut down of the separator and the separator shrinks at that time, the positive electrode and the negative electrode come into contact with each other (short-circuited). When this happens, the battery voltage drops abruptly from approximately 4.2 V to approximately 0 V.

In view of this, the battery voltage was continuously monitored during the heat resistance test to measure a length of time from when the test is started until when the battery voltage drops abruptly. The length of time thus measured is referred to as the separator shrinkage time. The results are shown in Table 3.

### COMPARATIVE EXAMPLE 3

A battery similar to that of Example 3 was fabricated, except that the C5 or more unsaturated chain hydrocarbon was not contained in the non-aqueous electrolyte and a predetermined amount of vinylene carbonate (VC) and/or vinyl ethylene carbonate (VEC) as shown in Table 3 was added therein, and then evaluated in the same manner as in Example 3. The results are shown in Table 3.

TABLE 3

| | VC | VEC | Type of additive | | Separator |
|---|---|---|---|---|---|
| | (part | (part | (C5 or more | Capacity | shrinkage |
| | by | by | unsaturated chain | retention | time |
| | weight) | weight) | hydrocarbon) | rate (%) | (min) |
| Ex. 3 | Nil | Nil | Piperylene | 83.0 | 22.8 |
| | Nil | Nil | 2,4-hexadiene | 86.0 | 23.0 |
| | Nil | Nil | 1,3,5-hexatriene | 83.5 | 22.7 |
| | Nil | Nil | 1,3,5,7-octatetraene | 81.3 | 22.7 |
| | Nil | Nil | 1,7-octadiene | 80.7 | 22.5 |
| | 1 | Nil | Piperylene | 84.8 | 49.0 |
| | 1 | Nil | 2,4-hexadiene | 87.5 | 50.3 |
| | 1 | Nil | 1,3,5-hexatriene | 85.0 | 49.4 |
| | 1 | Nil | 1,3,5,7-octatetraene | 83.4 | 48.8 |
| | 1 | Nil | 1,7-octadiene | 82.8 | 48.3 |
| | Nil | 1 | Piperylene | 85.0 | 49.2 |
| | Nil | 1 | 2,4-hexadiene | 87.9 | 50.5 |
| | 1 | 1 | Piperylene | 87.7 | 51.0 |
| | 1 | 1 | 2,4-hexadiene | 89.3 | 52.1 |
| Com. | 2 | Nil | Nil | 45.6 | 22.4 |
| Ex. 3 | Nil | 2 | Nil | 46.9 | 22.5 |
| | 2 | 2 | Nil | 57.1 | 22.1 |

As is evident from Table 3, significant improvement was observed in the battery including the C5 or more unsaturated chain hydrocarbon and VC and/or VEC, with respect to the heat resistance as well as the cycle characteristics at high temperatures. It is conceivable that a composite coating composed of a coating derived from the C5 or more unsaturated chain hydrocarbon and a coating derived from VC and/or VED was produced. The composite coating has a function of significantly enhancing the adhesiveness between the separator and the electrode. For this reason, even when the separator causes shut down by heating the battery to a high temperature, it is conceivable that the shrinkage of the separator is suppressed and thus the contact (internal short-circuit) between the positive electrode and the negative electrode is prevented, resulting in improvement in safety.

### EXAMPLE 4

To 100 parts by weight of a non-aqueous solvent composed of a mixture of ethylene carbonate (EC) and ethyl methyl carbonate (EMC) (volume ratio, EC:EMC=1:4), 2 parts by weight of the C5 or more unsaturated chain hydrocarbon as shown in Table 4 was added. In the resultant mixed solution, LiPF₆ and/or LiBF₄ was dissolved so that the concentration thereof becomes as shown in Table 4 to give a non-aqueous electrolyte. A battery similar to that of Example 1 was fabricated, except that the non-aqueous electrolyte thus obtained was used, and then evaluated in the same manner as in Example 1. The results are shown in Table 4.

### COMPARATIVE EXAMPLE 4

A battery similar to that of Example 1 was fabricated, except that the C5 or more unsaturated chain hydrocarbon was not contained in the non-aqueous electrolyte and LiBF₄ was dissolved in the non-aqueous solvent in place of the LiPF₆ at a concentration of 1 mol/L, and then evaluated in the same manner as in Example 1. The results are shown in Table 4.

TABLE 4

| | | | Type of additive | |
|---|---|---|---|---|
| | LiPF₆ | LiBF₄ | (C5 or more | Capacity |
| | (part by | (part by | unsaturated chain | retention |
| | weight) | weight) | hydrocarbon) | rate (%) |
| Ex. 4 | 1.0 | 0 | Piperylene | 84.0 |
| | 0.75 | 0.25 | | 85.0 |
| | 0.5 | 0.5 | | 85.5 |
| | 0.25 | 0.75 | | 86.1 |
| | 0 | 1.0 | | 86.9 |
| | 1.0 | 0 | 2,4-hexadiene | 86.8 |
| | 0.75 | 0.25 | | 87.9 |
| | 0.5 | 0.5 | | 88.3 |
| | 0.25 | 0.75 | | 88.9 |
| | 0 | 1.0 | | 89.8 |
| | 1.0 | 0 | 1,3,5-hexatriene | 82.2 |
| | 0.75 | 0.25 | | 83.4 |
| | 0.5 | 0.5 | | 84.1 |
| | 0.25 | 0.75 | | 84.7 |
| | 0 | 1.0 | | 85.7 |
| | 1.0 | 0 | 1,5-hexadiene | 83.2 |
| | 0.75 | 0.25 | | 84.6 |
| | 0.5 | 0.5 | | 85.0 |
| | 0.25 | 0.75 | | 85.5 |
| | 0 | 1.0 | | 86.3 |
| Com. | 0 | 1.0 | Nil | 32.1 |
| Ex. 4 | | | | |

As is evident from Table 4, the battery including the C5 or more unsaturated chain hydrocarbon as well as the LiBF₄ as a lithium salt was particularly excellent in cycle characteristics at high temperatures. It is presumable that LiF as a decomposition product of LiBF₄ was incorporated in the interior of a polymer coating produced by polymerization of the C5 or more unsaturated chain hydrocarbon, and thereby the lithium ion conductivity of the polymer coating was improved.

### INDUSTRIAL APPLICABILITY

A non-aqueous electrolyte secondary battery excellent in cycle characteristics at high temperatures can be obtained by use of the non-aqueous electrolyte according to the present invention. The non-aqueous electrolyte secondary battery excellent in cycle characteristics at high temperatures is useful as a power source for portable equipment, etc and the usability thereof is extremely high.

1. A non-aqueous electrolyte for a secondary battery comprising:
a non-aqueous solvent,
a solute dissolved in said non-aqueous solvent, and
an additive,
wherein said additive comprises an unsaturated chain hydrocarbon compound having two or more carbon-carbon unsaturated bonds and including a main chain having five or more carbon atoms.

2. The non-aqueous electrolyte in accordance with claim 1, wherein said unsaturated chain hydrocarbon compound is represented by the general formula (1): 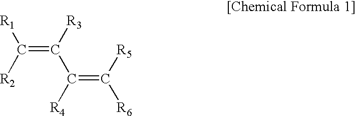
wherein each of R₁, R₂, R₃, R₄, R₅ and R₆ independently represents a hydrogen atom or an alkyl group having one to five carbon atoms, and at least one of R₁ to R₆ is an alkyl group whose main chain has five or more carbon atoms.

3. The non-aqueous electrolyte in accordance with claim 2, wherein said unsaturated chain hydrocarbon compound is 1,3-hexadiene or 2,4-hexadiene.

4. The non-aqueous electrolyte in accordance with any one of claims 1 to 3, wherein an amount of said unsaturated chain hydrocarbon compound is 0.1 to 10 parts by weight per 100 parts by weight of said non-aqueous solvent.

5. The non-aqueous electrolyte in accordance with claim 1, wherein said additive further comprises at least one selected from the group consisting of vinylene carbonate and vinyl ethylene carbonate.

6. The non-aqueous electrolyte in accordance with claim 1, wherein said solute comprises lithium tetrafluoroborate (LiBF₄).

7. A non-aqueous electrolyte secondary battery comprising:
a positive electrode capable of absorbing and desorbing lithium,
a negative electrode capable of absorbing and desorbing lithium,
a separator interposed between said positive electrode and said negative electrode, and
the non-aqueous electrolyte in accordance with claim 1.
